(19) United States
(12) Patent Application Publication
(10) Pub. No.: US 2026/0200563 A1
(43) Pub. Date: Jul. 16, 2026

(54) SYSTEMS AND METHODS FOR MARITIME ABDUCTION FOR REGION GENERATION TO EXPOSE DARK VESSEL TRAJECTORIES

(71) Applicants: Arizona Board of Regents on Behalf of Arizona State University, Tempe, AZ (US); EpochGeo LLC, Washington, DC (US)

(72) Inventors: Paulo Shakarian, Chandler, AZ (US); Divyagna Bavikadi, Tempe, AZ (US); Nathaniel Ezra Lee, Tempe, AZ (US); Jason Ribeiro, Charlottesville, VA (US); Chad Parvis, Front Royal, VA (US)

(21) Appl. No.: 19/450,477

(22) Filed: Jan. 15, 2026

Related U.S. Application Data
(60) Provisional application No. 63/745,753, filed on Jan. 15, 2025.

(51) Int. Cl. B63B 79/20; G06N 5/025; G06N 5/045

(52) U.S. Cl. CPC B63B 79/20; G06N 5/025; G06N 5/045

(57) ABSTRACT

A system can predict potential future locations of maritime vessels given historical maritime vessel trajectory data using abductive reasoning strategies. The system includes a learning component and reasoning component. The learning component creates a rule-based model that maps partial trajectory information to potential new locations, which the reasoning component can use to predict areas where a vessel may be based on partial trajectory information. This can be either area-based or trajectory based. The rule-based model also enables the system to learn normal trajectory behavior and characterize why such behavior is normal. The system can also infer multiple geospatial areas where a vessel may be located.

### CROSS-REFERENCE TO RELATED APPLICATIONS

This is a U.S. Non-Provisional Patent Application that claims benefit to U.S. Provisional Patent Application Ser. No. 63/745,753 filed 15 Jan. 2025, which is herein incorporated by reference in its entirety.

### GOVERNMENT SUPPORT

This invention was made with government support under N00014-23-1-2580 awarded by the Office of Naval Research. The government has certain rights in the invention.

### FIELD

The present disclosure generally relates to trajectory analysis in maritime forecasting, and in particular, to a system and associated method for identifying likely locations of a maritime vessel given partial trajectory information.

### BACKGROUND

Maritime vessels use the automatic identification system (AIS) to report their locations via satellite. However, sometime vessels stop reporting this information after a time—which can be caused by a malfunction, but often used in the case where a vessel goes “dark” to undertake illegal actions—such as violating sanctions or illegal fishing.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIG. 1 is a simplified diagram showing an example computing device for implementation of aspects of the systems outlined herein;

FIG. 2 is a simplified diagram showing deployment of abduction model of a system outlined herein in an online learning setting;

FIG. 3 is a graphical representation showing example abduction model predictions where a dashed trajectory denotes a ground truth and black regions denote generated regions with corresponding confidence and region types;

FIGS. 4A and 4B are a pair of graphical representations showing Area Efficiency: (a) Relationship between Recall and Area, (b) Recall per km² as a function of k;

FIG. 5 is a graphical representation showing Long-term reasoning, where F1@{k=5, k=10} for the Abduction-based methods outlined herein (ABD), Deep Learning (DL), and Random baselines;

FIGS. 6A and 6B are a pair of graphical representations showing comparison of: (a) F1@k metric and (b) Precision-Recall curve;

FIGS. 7A and 7B are a pair of graphical representations showing comparison of ML metrics: (a) Recall@k and (b) Precision@k;

FIG. 8 is a graphical representation showing region size sensitivity for different region-sizes (of LG denotes the larger region size=5.45 km² and SM denotes the smaller region size=1.1 km²);

FIG. 9 is a graphical representation showing F1 scores for various masking methods and rules, including AIS Off (SH), Stay (SH), 50 End (SH), and 50 End (MH), where SH represents single hop rules and MH represents multi-hop rules;

FIG. 10 is a graphical representation showing evaluation of ABD with limited training data (trajectories) where ABD performed smoothly, with variations in the number of training trajectories;

FIG. 11 is a graphical representation showing evaluation of ABD and DL with limited training data (trajectories), where DL achieved an F1 near zero with five training trajectories;

FIG. 12 is a graphical representation showing evaluation of runtime in terms of milliseconds of ABD as a function of k; and

FIG. 13 shows a precision-recall plot (as a function of k, the number of abduced regions) for a set of AIS data from the Persian Gulf.

Corresponding reference characters indicate corresponding elements among the view of the drawings. The headings used in the figures do not limit the scope of the claims.

### DETAILED DESCRIPTION

### 1 Introduction

Maritime vessels are equipped with an automatic identification system (AIS) to track their position on the globe. However, malicious actors often disable this system—becoming “dark” when conducting illegal activities. Understanding these “dark vessel” has implications for security, maritime analysis, planning, and forecasting. Recently, with the support of the U.S. Treasury and European Union in enforcing maritime services prohibitions for seaborne Russian oil, industry efforts have been made in real-world scenarios including piracy, illegal fishing, human trafficking, border protection, and sanction violations highlighting the increasing need for efficient dark vessel detection. Recent machine learning (ML) approaches are limited to trajectory prediction with a time horizon of less than an hour or rely on satellite data susceptible to weather conditions. Other approaches require expert intervention using radio frequency doppler shift. These approaches are not data-efficient and cannot explain why they determined a given result. We note that from a practical perspective, the limited forward-prediction value of ML approaches is significant—as the ability to find the dark vessel locations degrades with increased search area and resources. Meanwhile, recent work on generating faux trajectories for human movement suggests that abductive inference can address some of these difficulties—although that work does not predict real trajectories and was not applied to the maritime domain. In this disclosure, we combine ideas from abductive inference, logic programming, and rule learning to identify locations of dark vessels based on partial trajectory information. We show that we are able to approach full recall of dark vessel trajectories requiring less than half of the area coverage required by our machine learning baselines. Further, we found that the recall performance of the abduction-based approach increases with search area and resources—unlike the degradation experienced with ML. We also demonstrate data efficiency, efficient inference calculations, and describe our ongoing efforts to deploy this technology in an operational platform. After a review of background material (Section 2) we outline the following contributions:
(1) We provide a formalism for reasoning about maritime vessels including a logical language for expressing maritime vessel trajectories (Section 3.1) and the framing of an abduction problem (Section 4.2) that include a top-k approximation that we explore empirically in this disclosure.
(2) We provide a simple but effective rule-learning approach to agent behavior modeling (Section 4.3) that enables not only allows for data-driven (and data-efficient) abduction but also affords explainability of the results.
(3) We provide a suite of experimental results (Section 5) that demonstrate how the abduction approach is area-efficient by saturating with 157% higher recall than baselines for an area of 30 km², provides long-term predictions where ML methods fail, and provides improved performance of 476% in recall with additional resources.
(4) We also show that the approach is efficient in both terms of runtime and data as it can be instantiated with very little data—even a single training trajectory (providing comparable performance of 0.62 precision to the use of all historical data—where we show ML catastrophically fails), as well as provide various ablation studies.
(5) We describe our efforts to deploy this system in an operational platform to support real-world analysts in dark vessel discovery.

The systems outlined herein address the problem of vessels intentionally disabling or degrading their Automatic Identification System (AIS) transmissions to “go dark” during sanctions violations or other illicit activity, where an important operational task is to predict likely future ship locations from only a partial observed trajectory while also providing an analyst with an interpretable basis for why particular locations are plausible.

In some embodiments, the disclosed system learns a set of behavior rules from historical trajectories that characterize normal movement behavior over an area of interest partitioned into symbolic geospatial regions. Training data are processed to index trajectories and map observations into symbolic regions, and a rule-learning component produces a rule set (optionally including confidence/weight information) that relates temporal patterns and region-associated attributes (e.g., near-port/hotspot regions and other behavior predicates) to normal movement behavior. During operation, partial trajectory information from live-stream data is processed (e.g., by an attribution processor that derives region/behavior indicators from the stream), and a reasoning component applies an abductive inference technique to generate a region set (e.g., top-k regions) identifying candidate future locations at a future time. The system further generates an explanation by identifying one or more learned behavior rules that support one or more selected candidate locations, and outputs the region set and explanation for presentation (for example, as an overlay on a geospatial display).

### 2 Background

Dark Vessel Analytics. Maritime vessels employ deceptive shipping practices to benefit from violating international law, conducting illicit operations, violating environmental protections, and avoiding sanctions. In the 18th century, vessels disguised their Jolly Roger flags to deceive prospective victims before attacking them. Currently, vessels manipulate their AIS to avoid being monitored while performing illicit activities. On a monthly average, 800,000 dark activity events were detected in 2020-2022. Lately, in the aftermath of the Russia-Ukraine war, sanctions on maritime trade have evolved, and monthly dark activity rose by 216%. More recently, in 2024, there has been a 340% rise in dark activity much of which focused in the Black Sea (the area used in our experiments in Section 5). Such activities when gone undetected, can have realistic detrimental impacts on marine ecosystems, public safety, trade, and security. To monitor and control such behavior, efforts from government agencies, and industry, have invested in various efforts that began in earnest with the DARPA PANDA program over a decade ago. These programs have led to a line of research that we describe in the next subsection.

Related Work. Earlier work on maritime vessel trajectory prediction relied on Markov models, extensions have also been applied to make efficient predictions. Although they work well for simple finite parameters, they are unable to capture complex patterns and this led to the later use of deep learning techniques for the problem—enabled by the availability of large datasets of maritime trajectories. To address the complexities of spatio-temporal interactions, one previous work provides a sequence-to-sequence RNN to predict future maritime trajectories. Related work looks to predict a point ship location using a LSTM-transformer combination. These methods differ from the approach outlined in this disclosure in that they only provide accurate predictions up to an hour in the future, require large amounts of training data, and do not afford explainability (so the analyst user cannot easily justify the dark vessel predictions to operational personnel). Maritime trajectory patterns have also been studied widely with for traffic management with an unsupervised hierarchical method and safety where they mine patterns to focus on shipping route characterization and anomaly detection. These methods are valuable for understanding typical and atypical trajectory behavior, but they are primarily focused on identifying patterns after the fact. In contrast, the methods outlined herein leverage trajectory behavior through abductive reasoning to infer an agent's future locations. We also note that this work differs from other maritime applications of AI such as vessel detection where a model generates bounding boxes for the object vessel in an image or tracking it in a video. This work also differs from a complementary line of work of patrolling strategies that generates optimal patrol locations to cover a set of targets as we focus on generating locations to capture a target at a time horizon (as opposed to developing patrol plans for a non-adversarial agent).

Trajectory forecasting is a separate line of work, though this work is focused on short-time horizon prediction of human or robotic movement as opposed to the long-time horizon, global-scale prediction of maritime vessels. Some other notable approaches use deep learning architectures based on convolutional networks, adversarial methods, and autoencoders as well as Markov chains.

Abductive inference has provided a natural paradigm for locating unobserved adversarial agents—requiring much less data and providing more transparency than ML methods. Early work in this area offered simple models relating the adversary's point location to geospatial phenomenon. Later work took a data-driven approach to learn a model of the adversarial behavior that enables abductive inference. None of the aforementioned prior work on abduction involves trajectories nor does it involve making predictions of agent behavior over a long time horizon. Complementary to abduction work is the generation of spatial regions, which aims to maintain meaningful spatial boundaries for transportation services by partitioning an area of interest via region clustering (we employ similar techniques during pre-processing). More recent work on abductive inference has been applied to human movement. However, that work is designed to produce faux movement trajectories and not identify actual future agent locations. We note that it relies on a different approach (the use of A*) to create movement trajectories as opposed to this work that examines the problem as a top-k entailment query.

### 3 Computer-Implemented System

Maritime vessels may stop reporting location information via the Automatic Identification System (AIS), whether due to malfunction or, in some cases, intentional “going dark” while conducting illicit activities such as sanctions violations or illegal fishing. The disclosed embodiments address this operational need by predicting likely future ship locations from only a partial observed trajectory while also providing an analyst with an interpretable basis for why particular locations are plausible. In some embodiments, the approach combines abductive inference, logic programming, and rule learning to identify locations of dark vessels based on partial trajectory information and to provide explainability of the results. The system provides results for analyst review by outputting a region set and a corresponding explanation for presentation (for example, as an overlay on a geospatial display), where the explanation identifies one or more behavior rules that support one or more selected candidate locations in the region set.

In some embodiments, observations for a target vessel are represented using a temporally annotated logical language. For an annotated literal that is true at time t, the disclosure describes a “temporally annotated fact (TAF),” and a program Π may include rules and TAFs. As used herein, “partial trajectory information” may correspond to the “initial conditions of the agent,” described as areas the shipping vessel has traveled in the first part of its voyage, represented with an initial logic program Πᵢₙᵢₜ including temporally annotated facts formed with a domain-specific predicate at(agt, r) indicating that the agent is within a region r. In some embodiments, training and operational observations are processed to index trajectories and to map observations into symbolic regions, including by deriving region/behavior indicators from observed data and representing those indicators using the temporally annotated facts of the logic program. As used herein, an “initial-condition representation” may correspond to the initial logic program Πᵢₙᵢₜ (or an equivalent stored representation) generated from the partial trajectory information.

As used herein, “area of interest” (AOI) refers to a continuous geographic space under analysis, and the AOI may be associated with a set of regions Dᵣ described as “the set of all regions within the AOI,” which in practice may be defined based on historical trends ahead of time. The disclosure further describes regions parameterized by upper-right and lower-left corners and treated as sets of enclosed locations. As used herein, “geospatial regions partitioning an area of interest” and “candidate future region assignments” may correspond to selecting and evaluating candidate hypotheses formed from regions r chosen from Dᵣ, including top-k regions corresponding to TAFs at(agt, r) (picking r from Dᵣ) as described for the top-k variant. In some embodiments, the set of all regions within the AOI (Dᵣ) is assumed known a-priori for purposes of generating and evaluating candidate region hypotheses, and the system enumerates candidate regions by considering relevant singleton region hypotheses formed from atoms created with Dᵣ (e.g., at(agt, r) for r in Dᵣ). In some embodiments, a future time for prediction is determined as an offset from a last-observed time in the partial trajectory information, and candidate region hypotheses are enumerated from a predefined set of regions within the AOI (e.g., Dᵣ computed ahead of time).

In some embodiments, the system employs a rule-based model of vessel behavior expressed as a logic program Π_{behav} comprising behavior rules describing what vessels normally do. As used herein, “model information defining movement behavior” may correspond to such a set of behavior rules Π_{behav} specifying behavior of the agents. The disclosure describes that Π_{behav} could be designed to allow for “hard constraints on consistency,” but in some embodiments the rules are treated as “soft constraints” so that the degree of compliance can be measured and used to build a parsimony function. As used herein, a “constraint” may correspond to such “hard constraints on consistency” and/or “soft constraints” in Π_{behav}. As used herein, “model conditions” may correspond to rules and temporally annotated facts included in a logic program, and evaluating a candidate region hypothesis may include determining whether an interpretation satisfies those rules and temporally annotated facts (i.e., whether the candidate is consistent with, and supported by, the logic program). In some embodiments, the behavior rules (and associated confidence/annotation information) are stored in memory as a machine-readable rule representation (e.g., a logic program) configured for use by a reasoning component during operational inference.

The disclosure also describes domain-specific predicates used to express region-associated attributes and vessel behaviors, including nearport, change-direction, high-speed, low-speed, hotspot, draught, ais-off, and stay. As used herein, “region attribute,” “symbolic region type,” or “behavior predicate” may correspond to these domain-specific unary predicates and the associated semantic descriptions (e.g., near a port, high-density hotspot, varied draught, stopped transmitting AIS signals, staying put for a long duration). In addition, the disclosure describes learning movements among regions representing features like port regions, density-based historical hotspots, anchor points, destinations, and typically observed maritime feature (speed over ground, course over ground, and heading) spikes. As used herein, a “feature-based criterion” may correspond to criteria derived from (or expressed using) such “regions representing features” and/or the disclosed feature-related predicates (e.g., speed-related predicates and change-direction) used in the logic program.

To generate likely future locations, some embodiments pose trajectory prediction as an abduction problem: given initial conditions Πᵢₙᵢₜ, behavioral rules Π_{behav}, and (for evaluation) a ground-truth trajectory τ, the goal is to find a region set program Π_{R} that is consistent and supports entailment of trajectory elements as described in the abduction framing. The disclosure introduces an approximation and a parsimony-based scoring function—to rank region-set hypotheses, including a top-k approach that computes “top-k regions” corresponding to at(agt, r) in parallel for r in Dᵣ. As used herein, a “measure of fit,” “score,” “weight value,” or “confidence value” may correspond to the disclosed use of annotations as confidence bounds and the use of the lower bound in the parsimony function, where σₜ(agt, Π) is defined as the lower bound of the annotation interval for a normalcy predicate normal(agt) at time t in the minimal model Γ*(Π), and the disclosure notes using the maximum time to cover long-term predictions. In some embodiments, candidate region hypotheses are evaluated using entailment-based reasoning: for each candidate region hypothesis (e.g., a singleton at(agt, r) formed from Dᵣ), the system performs an entailment evaluation against the logic program and computes a scalar parsimony score used to rank the candidate region hypotheses. In some embodiments, the evaluation produces (i) identifiers of one or more satisfied rules and/or temporally annotated facts (as a basis for explanation) and (ii) a measure of fit used for ranking (e.g., the parsimony score), and the system selects a top-k set of regions according to the computed scores. As used herein, a “confidence interval” may correspond to the annotation interval associated with an atom in the temporally annotated logic language, and a “parsimony score” may correspond to a score computed from a bound (e.g., a lower bound) of such an annotation interval for a normalcy predicate.

In some embodiments, predicted region hypotheses are selected by computing an approximation function (e.g., \hat{ƒ}₁ or \hat{ƒ}₂) defined using an argmax over the parsimony function σ, thereby selecting a hypothesis that is maximizing σ or that is associated with the maximum a), subject to the explanation/prediction requirements described herein (e.g., consistency requirements for admissible explanations/predictions).

In some embodiments, rule learning is performed “from the training set,” learning a set of rules to model normal behavior based on “historical co-occurrences” of sequences. Algorithm 1 shows an implementation that scans trajectories τ in a training set T, counts occurrences of region identifiers and transitions (τ[n−1], τ[n]) in a dictionary Body, and constructs rules whose head annotation uses a ratio Body[moves]/Body[mov] as a confidence-related quantity. In some embodiments, each trajectory τ comprises a time-ordered sequence of observed region identifiers, and the rule-learning procedure counts occurrences of region identifiers and transitions between region identifiers in that time-ordered sequence. The disclosure also distinguishes “single-hop rules (SH)” and “multi-hop rules (MH)” and explains multi-hop rules as capturing movements that occur eventually rather than in the next movement. As used herein, a “single-hop” rule may refer to movement where a subsequent region identifier occurs immediately after a prior region identifier in the time-ordered sequence, and a “multi-hop” rule may refer to movement where at least one intermediate region identifier occurs between the prior region identifier and the subsequent region identifier in the time-ordered sequence. The disclosure further explains that “all regions are symbolic in nature” such that “every inference can be backtracked to the sequence of historically learned rules, in addition to its confidence,” supporting explainable outputs.

As used herein, “historical trajectory information” may correspond to the “training set” and AIS-derived trajectory data described as including latitude, longitude, timestamp, and other features, and to trajectories τ used for rule learning and evaluation (including masking a test trajectory to obtain a partial trajectory and using the unmasked part to set initial conditions Πᵢₙᵢₜ). In some embodiments, the historical and partial trajectory data include time-stamped position samples (e.g., latitude/longitude with a timestamp), and the time-stamped position samples are arranged as a time-ordered sequence for processing and inference.

In an online learning/deployment setting, the disclosure describes receiving input training data, performing batch indexing and generating symbolic regions, feeding processed data into a rule-learning microservice, and transforming learned rules into a logic program staged for use. In operation, live data is streamed via a near real-time Kafka feed; an attribution processor subscribes to the feed and enriches incoming data by tagging it with symbolic region and indexing metadata; the enriched data is integrated into the logic program (including updated rules and TAFs) and provided to a reasoner that infers k regions at a given time horizon; and the regions may be visualized in the area of interest for an end-user. In some embodiments, the visualization includes outputting, to a display device/interface, a visual representation of the inferred region set overlaid on the area of interest, together with explanatory information identifying one or more satisfied behavior rules for one or more selected regions.

In some embodiments, after the reasoning component infers k regions at a selected time horizon, the inferred regions are visualized in the area of interest for an end-user, such as by displaying the inferred regions on a geospatial interface.

As used herein, the verb “learn” (and related terms such as “learned”) refers to algorithmically deriving rules/logic programs and associated confidence bounds from data (e.g., scanning trajectories in a training set and computing head annotations/interval bounds that the disclosure treats as confidence), rather than requiring any particular machine-learning paradigm.

Finally, the disclosure also describes a deep-learning baseline in which a sequence-to-sequence model predicts future trajectories and the predicted sequence is mapped to regions in the AOI grid for comparable evaluation. This provides additional context for implementations in which a trained model outputs a predicted future trajectory that can be mapped to geospatial regions.

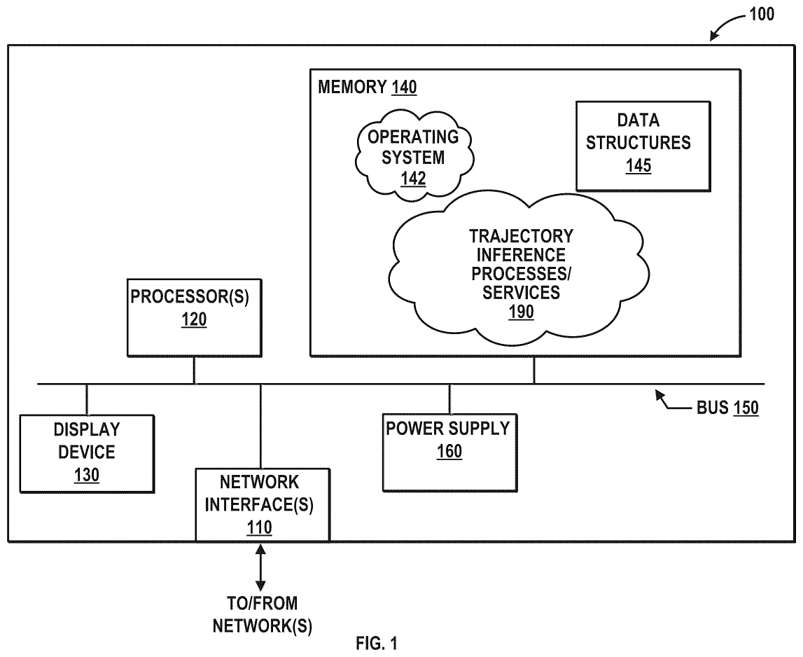

FIG. 1 is a schematic block diagram of an example device 100 that may be used with one or more embodiments described herein, e.g., as a component of a system implementing the abduction-based methods for trajectory prediction outlined herein.

Device 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.). Device 100 can also include or otherwise communicate with a display interface device 130 which can include one or more input/output devices that enable a user to input data, and to view or otherwise access output data. Input/output devices can include but are not limited to a monitor, a touch-screen, a speaker, a keyboard, a mouse, and the like.

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, device 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the systems and the methods outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes device 100 by, inter alia, invoking operations in support of software processes and/or services executing on the device. These software processes and/or services may include trajectory inference processes/services 190, which can include aspects of the methods and/or implementations of various modules described herein. Note that while trajectory inference processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the trajectory inference processes/services 190 is shown as a standalone process, those skilled in the art will appreciate that this process may be executed as a routine or module within other processes.

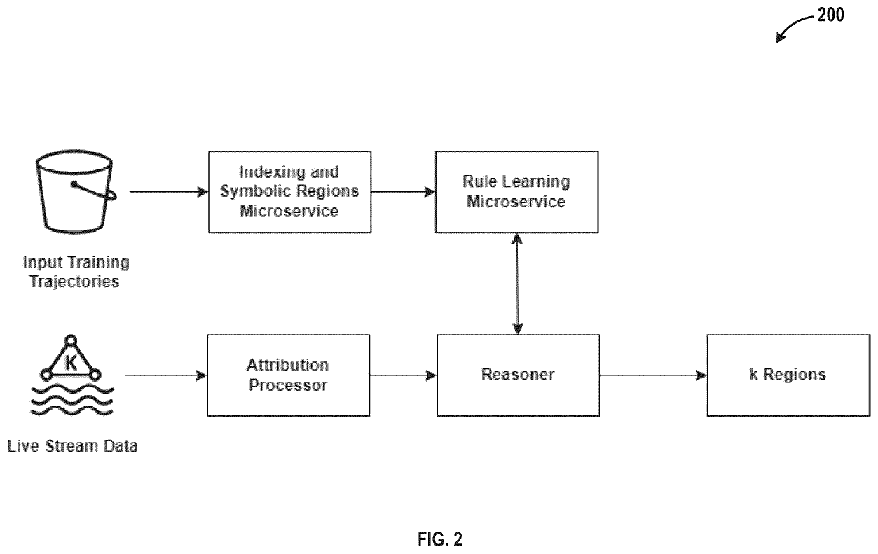

FIG. 2 depicts an architecture 200 of the computer-implemented system for near real-time detection of maritime dark vessels based on the abduction model outlined herein, where it continuously updates its logic program based on a live feed of trajectories as it generates regions in an online learning setting. A microservices-based embodiment of the architecture 200 that receives input training data delivered by data providers to an Amazon S3 bucket. The arrival of new data triggers a batch process that performs data indexing and generates symbolic regions. This processed data is then fed into a rule-learning microservice, which is subsequently transformed into a logic program by learning rules that are staged into the S3 bucket.

In a real/operational runtime setup, live data is streamed via a near real-time Kafka feed. We use Apache Kafka to consume the AIS data stream in near real-time as a streaming architecture. An attribution processor subscribes to this feed and enriches the incoming data by tagging it with the necessary symbolic region and indexing meta-data. The enriched data is then integrated into the logic program (which includes both updated rules and TAFs), before being fed into the reasoner (Γ*), which infers k regions at a given time horizon. We then use Quantum Geographic Information System software to visualize the regions in the area of interest for an end-user.

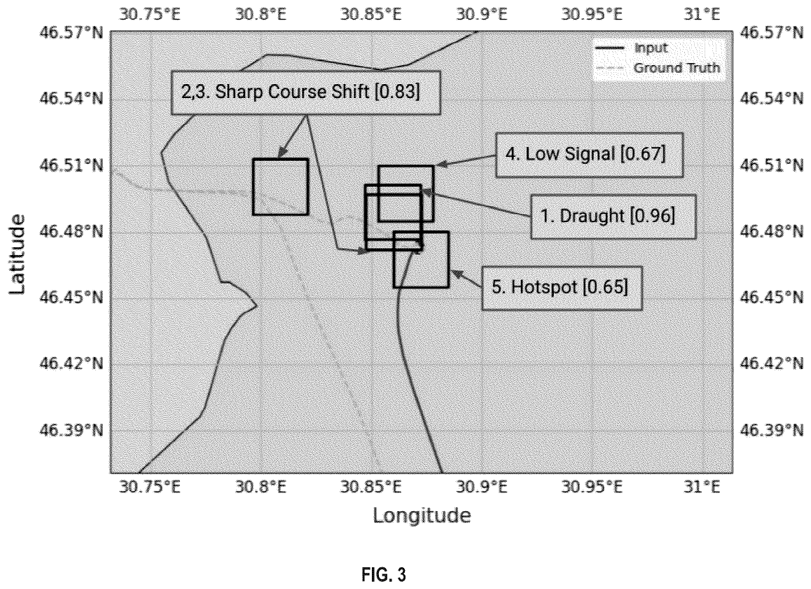

FIG. 3 illustrates an example output of the system for a target maritime agent (e.g., a vessel) that has an observed trajectory segment and then becomes unobserved (“goes dark”) at a time tᵢ. In the illustrated map view, the dashed trajectory corresponds to the ground-truth trajectory, and the black regions correspond to the generated regions returned by the abduction model for a selected future time horizon.

The disclosure also describes this same example in terms of an initial-conditions program Πᵢₙᵢₜ (capturing observed locations up to tᵢ) and a predicted “region set program” Π_{pred} (capturing predicted locations after tᵢ), where Π_{pred} can include multiple predicted region hypotheses at a future timepoint (e.g., multiple at(agent, region)ₜ_{ᵢ₊₁} facts). FIG. 3 further illustrates the system's explainability: each generated region can be accompanied by an explanatory label indicating a region type or behavior predicate and an associated confidence value for that region (e.g., labels such as draught, hotspot, and sharp course shift, each shown with a confidence value). These labels correspond to the disclosure's domain predicates used to express vessel behaviors and region-associated attributes (including, by way of example, hotspot, draught, and change-direction (changed course sharply), as well as ais-off (stopped transmitting AIS signals)). Consistent with the disclosure's description of explainability, because the regions are symbolic, “every inference can be backtracked to the sequence of historically learned rules, in addition to its confidence,” thereby supporting analyst review and interpretation of why particular regions were generated.

### 4 Approach

### 4.1 Logic for Maritime Agents

Logical Language. To define various aspects of the maritime domain environment, we use an annotated language with temporal semantics. The language is defined with a set of constants that is partitioned into multiple domains ( [symbol] ⊂ [symbol] ), one such subset, [symbol] _{loc}, is a set of all potential locations of the vessel in a continuous space (called an “area of interest” or AOI) of dimensions M×N. As usual in first-order logic, we define a corresponding set of variables ( [symbol] ), and a set of predicate symbols ( [symbol] ). Additional sets of constants include [symbol] ᵣ—which is the set of all regions within the AOI (and in practice, we will compute this based on historical trends ahead of time). When it is relevant, we shall subscript such constants with the upper-right and lower-left locations—e.g. r_{l1,l2}∈ [symbol] ᵣ is a region with upper-right corner l1 and lower-left corner l2 (note l1, l2∈ [symbol] ₁₀). In our definitions, we will treat an a set of all locations enclosed by the region. We also define set [symbol] _{agt} which is the set of agents (e.g., shipping vessels).

In addition to the first-order logic syntax and semantics, we allow for annotation [ [symbol] , u] which is simply a subset of the unit interval [0,1]—which generalizes both fuzzy and classical logic. We write a:[ [symbol] , u] to mean that a has truth value associated with interval [ [symbol] , u]. We refer the reader to Kifer et al. (Michael Kifer and V. S. Subrahmanian. 1992. Theory of Generalized Annotated Logic Programming and its Applications. J. Log. Program. 12, 3&4 (1992), 335-367.) and Shakarian et al. (Paulo Shakarian and Gerardo I. Simari. 2022. Extensions to Generalized Annotated Logic and an Equivalent Neural Architecture. In Proceedings—2022 4^{th} International Conference on Transdisciplinary AI, TransAI 2022. Institute of Electrical and Electronics Engineers Inc., 63-70.) for lattice-theory justification of this approach and how it generalizes other logical paradigms. We also note that we have learned our logic programs in a way to treat these bounds as confidence (see Section 4.3). We also follow the extension of temporal syntax and semantics to form temporally annotated facts (TAFs) and annotated formulae. For an annotated literal ƒ that is true at time t, ƒₜ is a TAF. Annotated formulae are constructs formed with operators like AFTER(ƒ, ƒ′). For annotated formulae ƒ, ƒ′, AFTER(ƒ, ƒ′) is interpreted as ƒ occurs after ƒ′.

EXAMPLE 4.1 (LANGUAGE). In our use-case, we consider an agent agt∈ [symbol] _{agt} that travels among loc1, loc2 . . . ∈ [symbol] _{loc} in an AOI. The agent can be at a location covered by a region r∈ [symbol] ᵣ where r⊆ [symbol] _{loc}. We also define domain-specific binary predicate at where at(agt, r) is a ground atom for an agent agt∈ [symbol] _{agt} at a located in r indicating that the agent is within the region of r. We also define domain-specific unary predicates formed with [symbol] _{agt} constants: nearport, change-direction, high-speed, low-speed, hotspot, draught, ais-off and stay (expressing that the agent is near a port, changed its course sharply, has a high/low speed compared to an average, at a high-density hotspot, varied its draught, stopped transmitting AIS signals, and is at an anchor point by staying put for a long duration).

As per previous work on temporal annotated logic, given a set of timepoints T, a set of all (ground) literals [symbol] , an interpretation I is any mapping [symbol] ×T→ [symbol] . We define a satisfaction relationship “ [symbol] ” and rules for temporally annotated extensions. A program Π is a set of rules, where each has an annotated atom in the head and a conjunction of annotated formulae in the body. An interpretation I is said to satisfy Π, if and only if I satisfies every rule and TAF in Π. The minimal model is an interpretation that can be thought of everything that can be concluded from deductive inference and commonly used for entailment queries in annotated logic. This is often computed using a fixpoint operator as done in the aforementioned work—and refer the reader to the well-established work on that topic for details. In this work, we use Γ*(Π) as shorthand to denote the minimal model of Π.

Initial and Predicted Locations. In our problem, we must represent the initial conditions of the agent—in other words, the areas the shipping vessel has traveled in the first part of its voyage. We represent this simply with the logic program including a set of temporally annotated facts formed with the predicate at introduced in Example 4.1. Here, we would expect fine-grain information on the location of the shipping vessel from information such as AIS—so each region (the second argument associated with the at-formed temporally annotated fact). We can think of such an initial logic program, Πᵢₙᵢₜ being complemented by an additional logic program—also created with temporally annotated facts—used to represent the agent's behavior in the future—Π_{pred}. Intuitively, the elements of Π_{pred} would resemble the elements of Πᵢₙᵢₜ except that they would occur after the facts of Πᵢₙᵢₜ. Further, in practice, we would expect regions associated with Π_{pred} to be larger than Πᵢₙᵢₜ. We shall refer to these logic programs Π_{pred}, Πᵢₙᵢₜ as region set program and provide an example below.

EXAMPLE 4.2. Consider an agent agt∈ [symbol] _{agt} in FIG. 3 that travels from time tᵢ to tᵢ (we notate timestamps to be a set of timepoints={t₁, . . . , tᵢ, . . . , tₙ} with a precedence relationship) and then goes dark at tᵢ, a time horizon tᵢ₊₁, then the initial conditions are represented as follows, Πᵢₙᵢₜ={at(agt, r_{(31.14,46.12),(31.11,46.09)})t₁, . . . , at(agt, r_{(30.88,46.48),(30.86,46.45)}) tᵢ} and the predictions are represented as follows, Π_{pred}={at(agt, r_{(30.87,46.51),(30.85,46.48)})tᵢ₊₁, at(agt, r_{(30.82,46.51),(30.79,46.48)})tᵢ₊₁, at(agt, r_{(30.88,46.48),(30.85,46.45)})tᵢ₊₁, at(agt, r_{(30.87,46.50),(30.84,46.47)})tᵢ₊₁, at(agt, r_{(30.87,46.49),(30.84,46.47)})tᵢ₊₁.

Behavior Rules. We also outline a logic program including a set of behavior rules of what the shipping vessel normally does (Π_{behav}). While it is possible to make these rules function as hard constraints, we instead make them soft constraints and instead measure how well an agent complies with these rules. This allows us to easily build a parsimony function. We provide example rules mined from data in Table 1.

Ground Truth Trajectories. Based on historical data, we also assume we have trajectory data for a given agent that occurs outside of Hini. For a given agent, such a trajectory is simply a series of location-time tuples that were observed in the ground-truth data. So for agent agt, trajectory τ_{agt}=((loc₁, t₁), . . . , (locᵢ, tᵢ), . . . , (locₙ, tₙ)). We will define a notion of entailment of a trajectory at the syntactic level (though it is trivial to derive a semantic version). We say that program Π entails an agent's trajectory τ_{agt} if for all (loc, t)∈τ_{agt} there is some TAF at(agt, r)ₜ∈Π (which occurs at the same time) such that loc∈r.

EXAMPLE 4.3. Following the notion built in Example 4.2, the trajectory for agent agt is, τ_{agt}∈ [symbol] (31.11, 46.00), t₁), . . . , ((30.87, 46.47), tᵢ), ((30.85, 46.48), tᵢ₊₁), ((30.81, 46.49), tᵢ₊₂), . . . , ((31.07, 46.00), tₙ) [symbol] , then Πᵢₙᵢₜ∪Π_{pred} [symbol] τ_{agt}. Note that tuples of τ_{agt}−τ¹, τⁱ are entailed by TAFs in Πᵢₙᵢₜ−(31.11,46.00)∈r_{(31.14,46.12),(31.11,46.09)}, (30.87, 46.47)∈r_{(30.88,46.48),(30.86,46.45)} and the others can be entailed from Π_{pred}−(30.85, 46.48)∈r_{(30.87,46.50),(30.84,46.47)}, and (30.81, 46.49)∈r_{(30.82,46.51),(30.79,46.48)}.

### 4.2 Abducing Agent Trajectories

For a single agent, we can think of finding Π_{pred} as an abduction problem. In other words, given an agent agt, initial conditions Πᵢₙᵢₜ, behavioral rules Π_{behav}, and ground-truth trajectory τ_{agt} we want to find Π_{pred} such that:
(1) Πᵢₙᵢₜ∪Π_{behav}Π_{pred} is consistent (i.e., Γ*(Πᵢₙᵢₜ∪Π_{behav}∪Π_{pred}) exists).
(2) For each Π_{pred} entails τ_{agt}

If these criteria are met, we say Π_{pred} is an explanation for [symbol] agt, Πᵢₙᵢₜ, Π_{behav}, τ_{agt} [symbol] . In this disclosure, our goal is to find a function that, based on historical data, can return an explanation. We define an explanation function as follows.

DEFINITION 1 (TRAJECTORY EXPLANATION FUNCTION). Given agents agt¹, . . . , agtⁿ, initial condition programs

$${Π}_{init}^{1} , … , {Π}_{init}^{n} ,$$

behavioral rules Π_{behav}, and trajectories Σ¹, . . . , τⁿ, we say an explanation function ƒ_{E} that takes as arguments and agent and two programs and returns a region set program such that

$${f}_{E} ( a g {t}^{i} , {Π}_{init}^{1} , {Π}_{b e h a v} )$$

is an explanation for

$$〈 {agt}^{i} , {Π}_{init}^{1} , {Π}_{behav} , {τ}^{i} 〉 .$$

We note that Definition 1 is quite strict as it requires the result of ƒ_{E} to produce a region set that models the entire trajectory for all agents. At the same time, it does not distinguish among different explanations. We introduce an approximation, \hat{ƒ}_{E} that is designed to meet the entailment requirement for as many agents as possible. Our solution is to leverage a notion of parsimony, defining \hat{ƒ}_{E} in terms of a parsimony function (σ)—which maps agents and logic programs to scalars. The idea is to use σ to measure the quality of an explanation so that we can find quality explanations that cover most of the ground truth trajectories. We provide the following examples of such a function.

$${\hat{f}}_{1} ( agt , {Π}_{init} , {Π}_{b e h a v} ) = arg {max}_{{Π}^{′}} σ ( agt , {Π}_{init} ⋃ {Π}_{b e h a v} ⋃ {Π}^{′} ) \\ {\hat{f}}_{2} ( agt , {Π}_{init} , {Π}_{b e h a v} ) = \{ arg {max}_{ϕ} σ ( agt , {Π}_{init} ⋃ {Π}_{b e h a v} ⋃ \{ ϕ \} ) \}$$

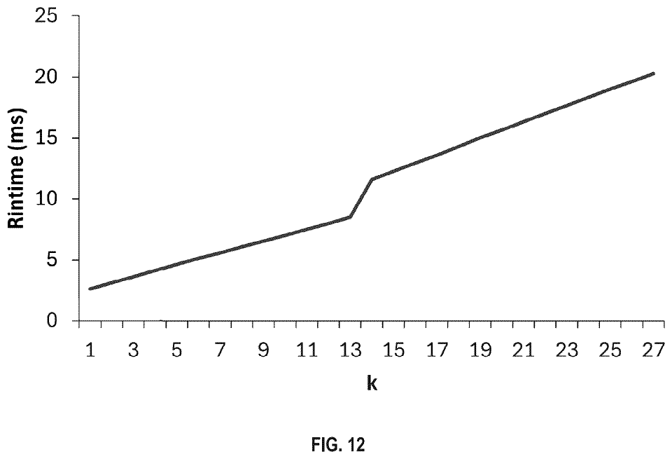

In these two examples, we note the first has a combinatorial flavor—finding the best set of regions, while the second identifies the best singleton set—a notion that we can extend to find the top k singletons (which correspond to the top k regions formed with the at). This can be easily solved by multiple entailment problems for each relevant singleton formed from atoms created with set [symbol] ᵣ (which we assume is known a-priori). We also note that the computation of \hat{ƒ}₂ can be computed in linear time (in the number of TAFs) which results directly from the prior results on annotated logic from Kifer et al. and Shakarian et al. and allows us to leverage existing efficient implementations. We verify this empirically (FIG. 12). In this work, we examine the top-k variant of \hat{ƒ}₂ and provide empirical evidence that supports it. In practice, we compute top-k regions—corresponding to the TAF at(agt, r) (picking r from [symbol] ᵣ) in parallel.

### 4.3 Rule-Based Agent Behavioral Modeling

As described in Section 4.1 we assume that there exists a set of rules Π_{behav} specifying the behavior of the agents. While we could design Π_{behav} to allow for hard constraints on consistency (and while there are good reasons for doing so), we instead leverage the fuzzy nature of our underlying logic (as described in Section 4.1) which can then allow us to easily build an explainable parsimony function a. Again, this function takes an agent and a logic program as arguments (and the logic program, Π, is the union of the initial conditions Πᵢₙᵢₜ and behavior rules Π_{behav}) and returns a scalar. As we use the logical paradigm of Kifer et al. and Shakarian et al., each logical atom is associated with a subset of the unit interval—[ [symbol] , u]. In this work, define the parsimony function as the aggregate over the lower bound of the interval, formally:

$${σ}_{t} ( agt , Π ) = l b ( Γ * ( Π ) ( normal ( agt ) ) ( t ) )$$

Intuitively, we have a predicate normal, such that atoms formed with that predicate are annotated with an interval measuring the agent's level of normalcy. The minimal model of the program, Γ*(Π) provides this annotation for a particular atom—here normal(agt) (the normalcy of agent agt) and time t (we can define a for a particular time—in practice we use the maximum time as it allows us to cover long-term predictions). Finally, lb returns the lower bound of the interval (as we will learn rules in a manner where we set the upper bound to 1 to easily ensure consistency).

Rule Learning Algorithm. From the training set, a set of rules is learned to model the normal behavior of the vessels based on the historical co-occurrences of periodic sequences among similar types of ships in similar waters. They are learned in a method akin to rule learning in Bavikadi et al. (Divyagna Bavikadi, Dyuman Aditya, Devendra Parkar, Paulo Shakarian, Graham Mueller, Chad Parvis, and Gerardo I Simari. 2024. Geospatial Trajectory Generation via Efficient Abduction: Deployment for Independent Testing. In Proceedings of the 40th International Conference on Logic Programming (ICLP 2024).) and Shahir et al. (Amir Yaghoubi Shahir, Mohammad A. Tayebi, Uwe Glässser, Tilemachos Charalampous, Zahra Zohrevand, and Hans Wehn. 2019. Mining Vessel Trajectories for Illegal Fishing Detection. In 2019 IEEE International Conference on Big Data (Big Data). 1917-1927.) where we restrict the body to have a single sequence of movement, refer Algorithm 1. These rules are population-specific among the vessels. Here, consider τ to be a set of the associated region of the trajectory. We note that Algorithm 1 is quite efficient. It scans all trajectories in a given data. The quantity of trajectory size in terms of regions can be treated as a constant as it's from a data source. Hence, it turns out that Algorithm 1 is linear in terms of the size of the dataset (number of trajectories).

Algorithm 1 Behavioral Rule Learner

| | |
|---|---|
| 1: | Input: A set of trajectories T, atom normal(agt) |
| 2: | Output: A set of rules Π |
| 3: | function RULES(Body) |
| 4: | Π ← ∅ |
| 5: | for all moves ∈ Body do |
| 6: | if length(moves) = 2 then |
| 7: | mov ← Body [moves] [0] |
| 8: | $\begin{matrix}\prod ← \prod ⋃ \{ normal ( agt ) \text{:} \\ [ \frac{Body [ moves ]}{Body [ mov ]} , 1 ] ← {\hat{}}_{m ∈ moves} m ( agt ) \}\end{matrix}$ |
| 9: | end if |
| 10: | end for |
| 11: | return Π |
| 12: | end function |
| 13: | function TRAINMODEL(T) |
| 14: | Initialize dictionary Body ← 0 |
| 15: | for all τ in T do |
| 16: | for n ← 1 to length(τ)-1 do |
| 17: | Body [τ[n]] ← Body [τ[n]] + 1 |
| 18: | Body [τ[n − 1]] ← Body[τ[n − 1]] + 1 |
| 19: | Body[(τ[n − 1], τ[n])] ← Body[τ(n − 1), τ[[n]] + 1 |
| 20: | end for |
| 21: | end for |
| 22: | Π ← Rules(Body) |
| 23: | return Π |
| 24: | end function |

Here the movement is considered to be among regions representing features like port regions, density-based historical hotspots, anchor points, destinations, and typically observed maritime feature (speed over ground, course over ground, and heading) spikes in the waters. We define two kinds of rules based on the movement from the current region. It could be one (single-hop rules (SH)) or multiple hops (multi-hop rules (MH)) away to the next region. For multi-hop rules, intuition is to capture movements that occur eventually rather than in the next movement from the current region. Some sample rules that we actually mined from maritime vessel data are shown in Table 1. The annotations on the head of the rules note the measure of confidence in the normalcy of the rule.

### 5 Experimental Results

Setup. We parsed Automatic Identification System (AIS) data of 614 vessels across the Black Sea area of interest (AOI) from January 2022 to March 2023. This involves the trajectory data τ of each vessel in addition to its dynamic and statistical information. This data has trajectories of the length 2 to 165,000 data points (i.e., the vessel's latitude, longitude, timestamp, other features¹) that span from 1 to 264 days. For all our experiments, we use a high memory compute node, Dell PowerEdge R6525 with the AMD EPYC 7713 64-Core Processors and 2 TB RAM, and a GPU node, Dell PowerEdge R7525 with the AMD EPYC 7413 24-Core Processors, 512 GB RAM along with three A30 GPUs. The region size is fixed arbitrarily at 0.025°×0.025° which comes to 5.45 km² in our AOI for our experiments unless specified. ¹Information from an AIS signal, https://spire.com/whitepaper/maritime/introduction-to-automatic-identification-systems-ais/

TABLE 1
Example Rules Mined From Historical Data

| Rule | Natural Language |
|---|---|
| normal(AGT): [0.8, 1] ← nearport(AGT): | Example Multi-hop rule. The confidence |
| [1, 1] Λ high − hotspot(AGT): [1, 1] Λ | of a vessel exhibiting normal behavior is |
| AFTER(high − hotspot(AGT), nearport(AGT)): | at least 0.8 when the agent goes from a |
| [1, 1] | near port to a high-hotspot region in |
| | more than a single movement. |
| normal(AGT): [0.9, 1] ← low − speed(AGT): | Example Single-hop rule. The |
| [1, 1] Λ sharp − course − change(AGT): | confidence of a vessel exhibiting normal |
| [1, 1] Λ AFTER(sharp − course − | behavior is at least 0.9 when the agent |
| change(AGT), low − speed(AGT)): [1, 1] | changes its course direction after |
| | lowering its speed in a single movement. |

Extending prior work where similar vessels were grouped, we perform trajectory clustering to group trajectories into 9 subset. Clustering is performed with DBSCAN and we report average metrics across all clusters for both our method and our deep learning baseline.

Since we aim to generate regions at a future time, we mask each test trajectory to obtain a partial trajectory. The masked part is considered the ground truth (ground truth trajectory τagt in our notation) while the unmasked part is used to set the initial condition (logic program Πinit). We mask half the trajectory from its midpoint in all our experiments unless specified.

Methods. We examine three methods, described as follows.

Random baseline (RND). The random method randomly generates regions from the AOI grid. The AOI grid is formed with cells of the fixed region size. The average performance of three random generators is reported.

Deep learning baseline (DL). For the DL baseline, we use a sequence-to-sequence model to predict future trajectories. To perform a comparable evaluation, the predicted sequence is mapped to regions in the AOI grid. Here k is a hyperparameter considered as the first k boxes encountered by the predicted sequence. We also evaluated a deep learning baseline trained on all the data (DL-ALL), which generally was not performant beyond k=4 limiting its F1—we include results from that model only in experiments where it significantly outperforms DL models on subsets. We experimented with variants having alternative architectures similar to point-based prediction models but these achieved worse results than DL and DL-ALL.

Abduction (ABD). The abduction method uses train data to obtain a set of regions (which is the subset of the AOI grid), from which it learns SH rules to obtain Π. Given a test trajectory, it then generates top k regions using \hat{ƒ}_{E} via abductive inference.

Metrics. We report precision as the fraction of returned regions that include points in the ground truth trajectory. Likewise, recall is the ratio of returned regions including ground truth points to all regions including irredundant points from the ground truth trajectory. The F1 is the harmonic mean of these quantities.

### 5.1 Experiments

We examine the ABD, RND, and DL approaches when applied to AIS data. We first inspect the area efficiency, which has practical significance. We then evaluate the methods for long-term reasoning capabilities. Further, we compare all approaches as a function of k in a standard setting. We also provide hyperparameter sensitivity concerning region size as well as ablation studies for Π (based on different rule types, e.g. SH, MH rules), and the versatility to masking methods of the test trajectory. Finally, we assess ABD while limiting the training data. We conclude by showing the interpretability of results in ABD.

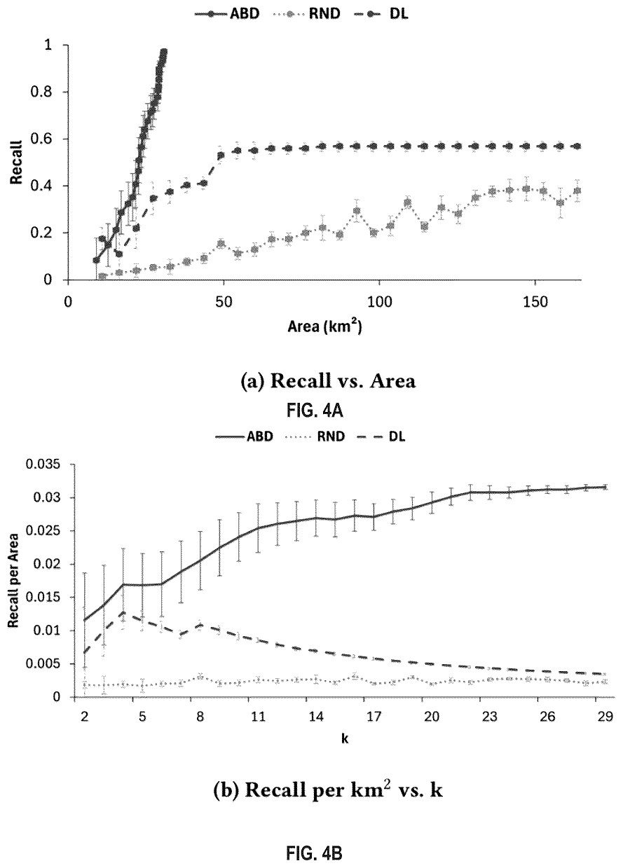

Area Efficiency. In our application, we wish to identify the greatest number of locations for dark vessels while searching the smallest area possible—as identification of dark vessels would require resources such as aerial or satellite imaging. We examine recall as a function of area in FIG. 4A. We found that recall for ABD saturates at 30 km²—achieving a recall of 0.99, which is 157% higher recall than DL for that area. DL meanwhile saturates at 81.75 km²—achieving recall of only 0.57. This difference suggests that ABD provides more efficiency per unit area. To further investigate this efficiency, we examine how it trends as a function of k (number of regions) in FIG. 4B. It turns out that the recall per square kilometer monotonically increases with k for ABD while it decreases for the baselines. This implies that ABD can continue to produce quality regions. This is significant for practitioners because, when additional search resources are available, ABD can continue to improve search efficiency with the addition of more search resources.

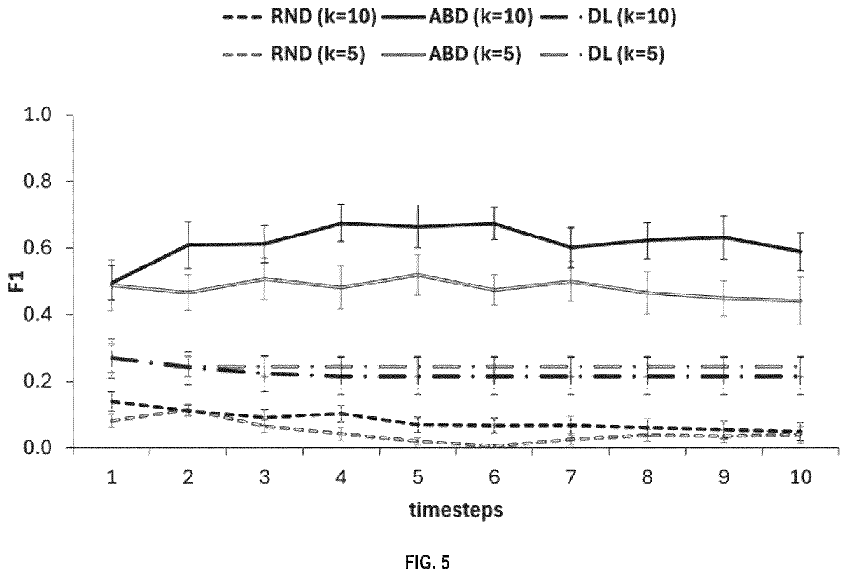

Long-term Reasoning. The prior experiments examined performance under the assumption of a fixed time horizon. Next, we examine performance across multiple time horizons and show the results in FIG. 5. Here we examine each approach with different settings for k but find that ABD again consistently outperforms other methods in terms of F1. We also note that ABD is the only approach where an increase in k improves results (e.g., DL achieves poorer performance with k=10 vs. k=5). This suggests that our previously described efficiency results likely hold to the case of multiple time units while DL convergers by leveling off after the first time horizon. This illustrates that with increasing time horizons, DL is not able to predict long-term trajectories.

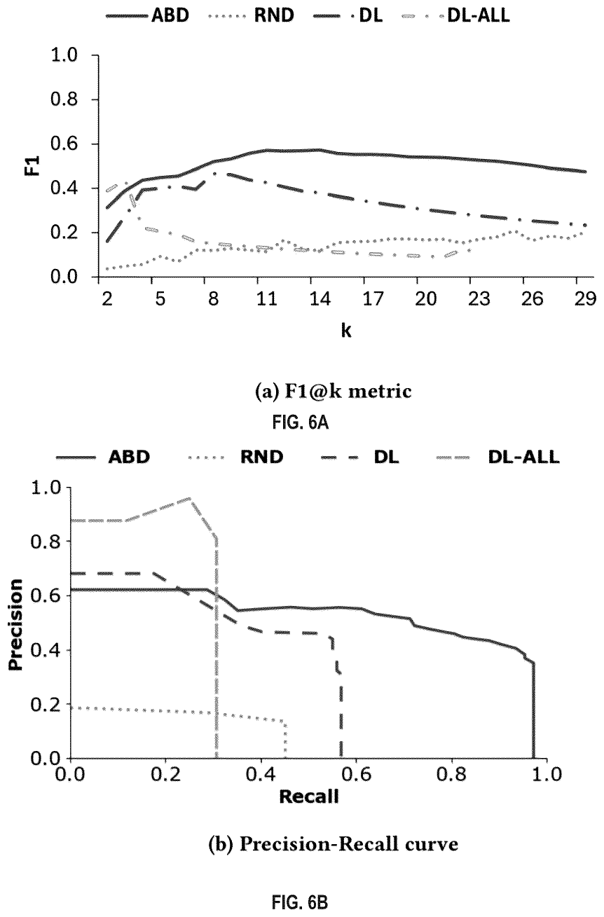

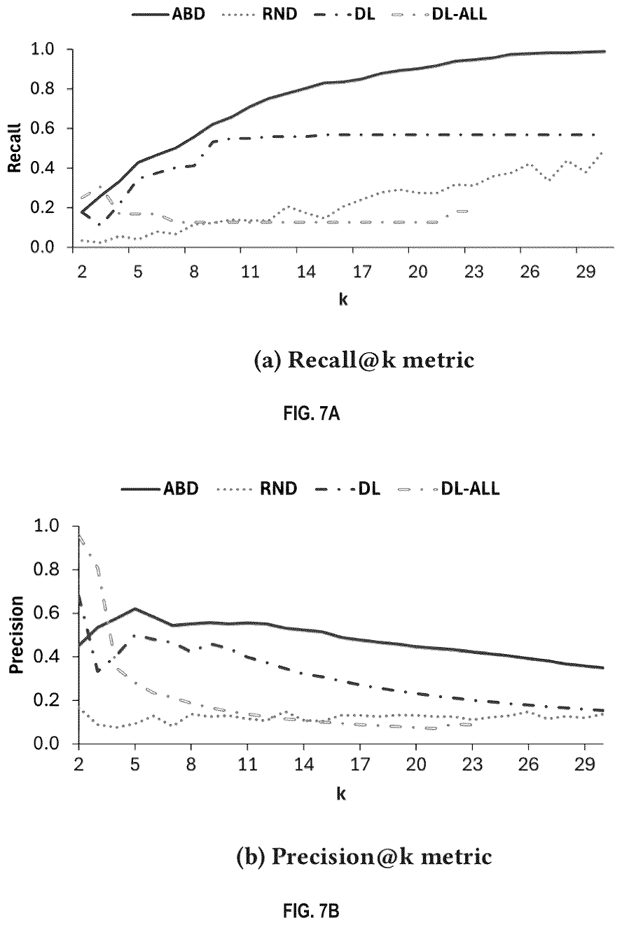

Vessel Recall and Accuracy. We examine ABD, DL (when trained on the subset datasets individually, as well as on the entire train set), and RND allowing for different values of k (number of regions). Note that the default DL is DL-Subset. FIG. 6A shows that across all settings of k, ABD outperforms all other methods in terms of F1—and ABD on average provides a 51% increase over DL. We note for higher values of k, DL starts to converge with the random baseline (i.e., around k=28) while ABD maintains approximately double the F1 score. When we examine the precision-recall curve in FIG. 6B, we gain an intuition as to why the F1 flags for the DL approach—and the answer is that the recall of DL saturates at 0.57—indicating limited value in adding more regions (increasing k) where ABD can obtain a recall approaching 1 while increasing k, with graceful degradation of precision. ABD has a 476% increase in the recall by adding more regions up to k=30. In this experiment, we also recorded the results of DL-ALL (a single model trained with the whole dataset instead of the sub-datasets). For k=3, 4, DL-ALL gave the highest F1 due to larger precision values (as seen in FIGS. 7A and 7B) but the performance degrades by 56% for a unit increase in k, and as k increases to 30, it degrades further. Additionally, as seen in FIG. 6B, similar to DL, DL-ALL also saturates and does not achieve a recall beyond 0.3, explaining the decrease in F1. Also, DL-ALL performed 50% lower on F1 when compared to standard DL. DL-ALL gives the highest F1 for time horizons very near to the current time. While this is less relevant for our current application, it may provide insight for further inquiry (e.g., a neurosymbolic approach leveraging both abduction and a model trained on a large number of trajectories).

Region Size Sensitivity. In the aforementioned experiments, we determined the region size by considering the computational efficiency of rule learning and generating regions with fair coverage-so that a single region does not end up covering the entirety of the vessel-search space. We now call that setting LG, while the setting SM is when we reduce the region size by 80%.

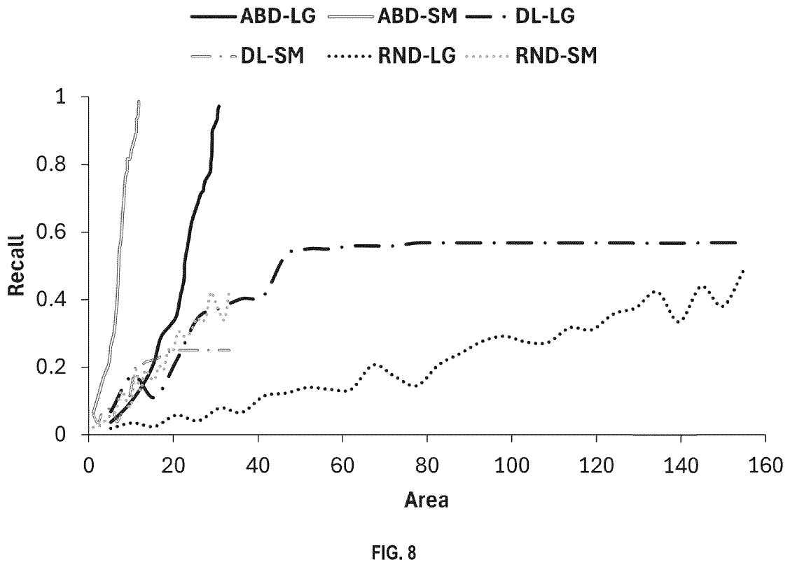

Note that reducing the region size (SM) is effective by itself as seen by RND-SM achieving comparable performance to DL-LG up to a certain extent. However, ABD outperforms all baselines particularly when the region size is reduced. The curve is steeper for ABD when the region size is decreased by 80% from LG to SM depicted in FIG. 8, while that of DL resembles its performance in the earlier experiment. We found that not only that our results maintain with reduced region size, but they also led to improved performance in ABD (reducing the total search area by about 60%) while the reduction in region size did not meaningfully change the performance of DL.

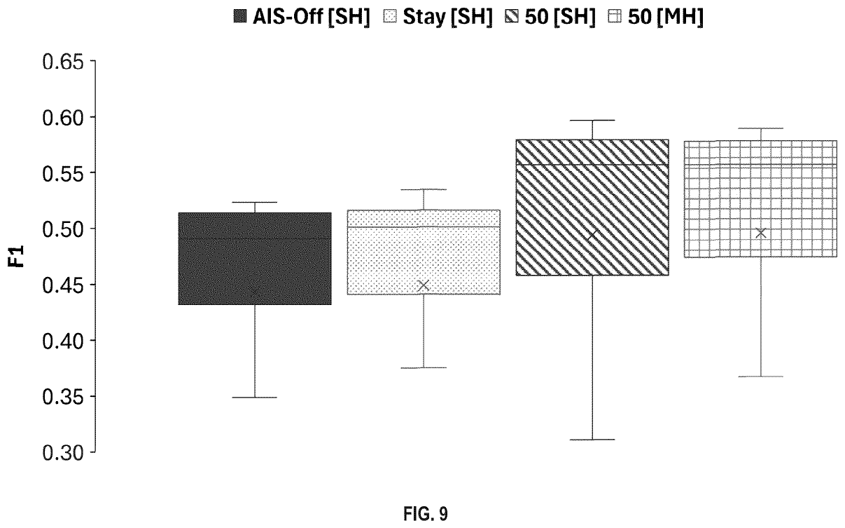

Ablation by Rule Type and Masking Sensitivity. As described in Section 4.3 we developed several methods to learn rules (see Table 1). In FIG. 9, our abduction (ABD) approach still works well for different kinds of rules like single-hop and multi-hop rules. Note that single hop has a slightly wider range of F1 scores with respect to the lower extremes by 0.05 while the upper extremes and medians are similar. Additionally, we also wanted to examine the impact of the type of masking on the results—from a practical standpoint to model applications for detecting deceiving vessels who tamper with their AIS transmitter. Here, the masking would typically start from a point where the AIS is tampered with. The abduction model works under various masking settings like when the making starts where the vessel does not transmit any AIS signal for more than normal time or stays in the same region for too long based on historical data. This shows that the model can be applied to both the detection of dark vessels and detecting vessels when they tamper with their AIS to violate sanctions.

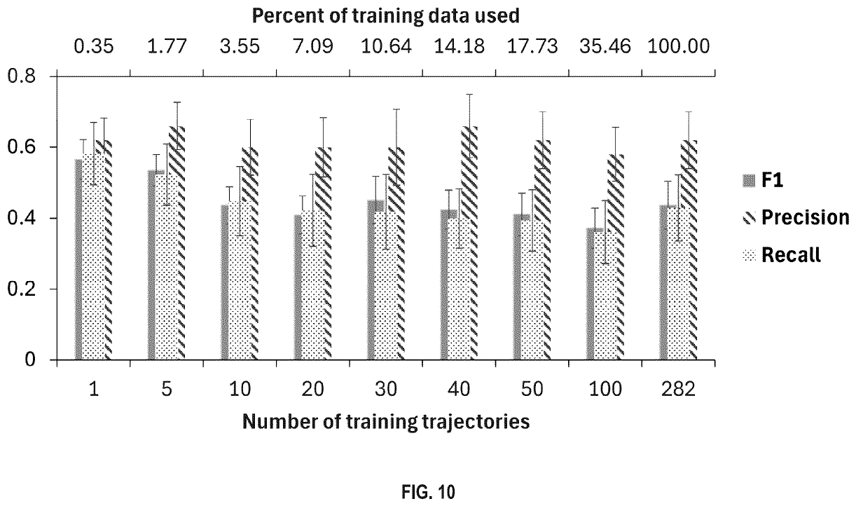

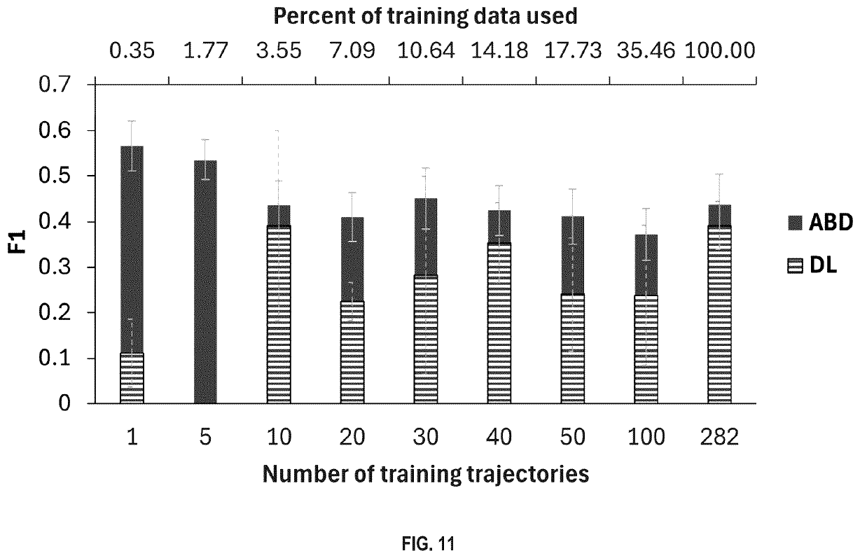

Data Efficiency. The abduction (ABD) model also works well with limited training trajectories as seen in FIG. 10 while DL-based methods are more data-driven as seen in FIG. 11. Note that for ABD, the use of a single training trajectory versus all of the historical data gave the same precision of 0.62 and a 0.13 difference in F1. On the other hand, as expected, DL has a huge variation with increasing training trajectories by boosting its performance by 254% as seen in FIG. 11. This gives scope for the application of this model with expensive or limited available data.

Runtime. In FIG. 12 we examine the runtime of ABD as a function of the number of regions k. As expected, the runtime increases linearly with k as this simply involves additional deductive steps. Further, we note that the deduction itself is efficient (linear in the size of nodes) as previously reported.

Explainability. All regions are symbolic in nature, every inference can be backtracked to the sequence of historically learned rules, in addition to its confidence as seen in FIG. 3. This gives scope for domain experts in analyzing false predictions, assess vessel behavior, and even incorporating domain knowledge into the rules.

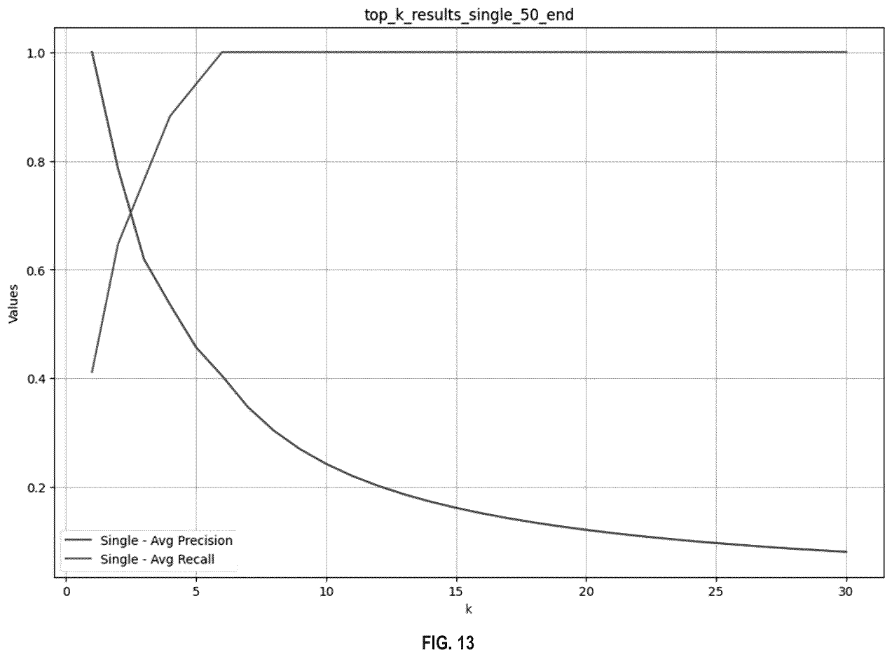

FIG. 13 further shows a precision-recall plot (as a function of k, the number of abduced regions) for a separate set of AIS data from the Persian Gulf.

### 6 Conclusions

We identify the locations of dark maritime vessels using a combination of abductive inference and rule learning and provides explainable long-time horizon prediction—an area where machine learning approaches fail. These aspects were validated by our experimental results and we provide our deployment architecture with a live feed of data. This work can be extended by leveraging environmental knowledge in the logic program, which has a significant role in the maritime domain where we look to utilize techniques from neurosymbolic AI that will enable the use of larger scale models for enhanced near-term precision while retaining the long-term reasoning ability of the abduction methods introduced in this disclosure.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory storing instructions executable by the processor to:
(a) access input data including (i) partial trajectory information for an agent and (ii) model information defining movement behavior of agents over geospatial regions partitioning an area of interest;
(b) generate a plurality of candidate future region assignments for the agent at a future time;
(c) for each candidate future region assignment, execute an evaluation operation that applies the model information to the partial trajectory information and the candidate future region assignment to produce an evaluation result that identifies (i) one or more model conditions defined by the model information which are satisfied by the candidate future region assignment and (ii) a measure of fit of the candidate future region assignment to the model information;
(d) generate, from the evaluation results, a region set including top-k candidate future region assignments by computing respective scores for the candidate future region assignments from the evaluation results and selecting the top-k candidate future region assignments according to the respective scores; and
(e) output, to a display device, (i) a visual representation of the region set overlaid on the area of interest and (ii) an explanation identifying one or more model conditions satisfied by at least one selected candidate future region assignment.

2. The system of claim 1, the model information including a plurality of model conditions, each model condition specifying at least one of a movement rule, a constraint, or a feature-based criterion, and each model condition being associated with a respective weight value or confidence value.

3. The system of claim 2, wherein at least one model condition specifies a movement rule that relates a first geospatial region at a first time to a second geospatial region at a second time.

4. The system of claim 2, wherein the model information is learned from historical trajectory information for a plurality of agents, and the respective weight values or confidence values are learned from the historical trajectory information.

5. The system of claim 2, wherein at least one model condition is conditioned on at least one region attribute associated with a geospatial region, the region attribute including a symbolic region type or behavior predicate associated with the agent in the geospatial region.

6. The system of claim 5, wherein the region attribute includes at least one of nearport, hotspot, ais-off, stay, draught, high-speed, low-speed, or change-direction.

7. The system of claim 1, wherein the partial trajectory information includes time-stamped position samples, and the instructions further cause the processor to map the time-stamped position samples to respective geospatial regions by tagging the time-stamped position samples with symbolic region identifiers to produce a time-ordered sequence of observed region identifiers for the agent.

8. The system of claim 1, wherein the future time is determined as an offset from a last-observed time in the partial trajectory information, and the candidate future region assignments are generated for the future time by enumerating candidate geospatial regions within the area of interest from a predefined set of regions, the predefined set of regions comprising the geospatial regions partitioning the area of interest.

9. The system of claim 1, wherein executing the evaluation operation includes performing a rule-based inference operation that produces, as the evaluation result, identifiers of model conditions satisfied by the candidate future region assignment.

10. The system of claim 1, wherein executing the evaluation operation includes evaluating an optimization objective subject to one or more constraints specified by the model information, and the respective scores are based on values of the optimization objective, and wherein the optimization objective comprises maximizing a parsimony score, the parsimony score comprising a lower bound of a confidence interval associated with an inferred normalcy predicate for the agent at the future time.

11. The system of claim 1, wherein the model information includes a trained machine learning model configured to output a predicted future trajectory for the agent, and the region set includes k geospatial regions obtained by mapping the predicted future trajectory to geospatial regions within the area of interest.

12. A system, comprising:
a processor in communication with a memory, the memory storing instructions executable by the processor to:
(a) access historical trajectory information for a plurality of agents within an area of interest, the historical trajectory information including, for each respective agent, a respective historical trajectory represented as a time-ordered sequence of observed geospatial region identifiers for the respective agent;
(b) generate, from the time-ordered sequences of observed geospatial region identifiers of the historical trajectory information, model information comprising a plurality of movement behavior rules that relate (i) a first observed geospatial region identifier of a time-ordered sequence at a first time to (ii) a second observed geospatial region identifier of the time-ordered sequence at a second time;
(c) assign, to each movement behavior rule, a respective weight value based on the historical trajectory information; and
(d) store the movement behavior rules and the respective weight values in a machine-readable rule representation configured for use by a reasoning component to (i) evaluate candidate future region assignments for a target agent based on partial trajectory information for the target agent and (ii) output an explanation that identifies at least one movement behavior rule supporting a selected candidate future region assignment.

13. The system of claim 12, wherein assigning the respective weight value for a given movement behavior rule comprises computing, from the historical trajectory information, a ratio of:
(i) a first count of occurrences, in the time-ordered sequences of observed geospatial region identifiers, of a transition from the first observed geospatial region identifier to the second observed geospatial region identifier; to
(ii) a second count of occurrences, in the time-ordered sequences of observed geospatial region identifiers, of the first observed geospatial region identifier.

14. The system of claim 12, wherein at least one movement behavior rule includes a temporal ordering operator indicating that a first predicate occurs after a second predicate.

15. The system of claim 12, the plurality of movement behavior rules including:
(i) single-hop rules in which the second observed geospatial region identifier occurs at a time immediately following the first observed geospatial region identifier in the time-ordered sequence of observed geospatial region identifiers; and
(ii) multi-hop rules in which at least one intermediate observed geospatial region identifier occurs between the first observed geospatial region identifier and the second observed geospatial region identifier in the time-ordered sequence of observed geospatial region identifiers.

16. The system of claim 12, wherein the instructions are further executable by the processor to:
(a) access the partial trajectory information for the target agent;
(b) generate a plurality of candidate future region assignments for a future time;
(c) for each candidate future region assignment, apply the movement behavior rules of the machine-readable rule representation to the partial trajectory information and the candidate future region assignment to determine (i) one or more movement behavior rules satisfied by the candidate future region assignment and (ii) a score for the candidate future region assignment based on the respective weight values associated with the one or more movement behavior rules;
(d) select, based on the scores, a candidate future region assignment as the selected candidate future region assignment; and
(e) output the explanation identifying at least one movement behavior rule determined to be satisfied for the selected candidate future region assignment.

17. The system of claim 16, wherein outputting the explanation further comprises outputting, for each identified movement behavior rule, the respective weight value associated with the movement behavior rule.

18. A computer-implemented method, comprising:
(a) accessing, at a processor in communication with a memory, partial trajectory information for an agent;
(b) accessing model information defining movement behavior of agents over an area of interest, the model information including a set of behavior rules;
(c) generating, using an abductive inference technique and based on the partial trajectory information and the model information,
(i) a region set that identifies one or more potential new locations for the agent at a future time, and
(ii) an explanation for behavior of the agent that identifies at least one behavior rule of the set of behavior rules supporting at least one potential new location in the region set; and
(d) outputting, to a display device, the region set and the explanation.

19. The computer-implemented method of claim 18, further comprising constructing the set of behavior rules from historical trajectory information for a plurality of agents, wherein the constructed set of behavior rules models normal behavior of the plurality of agents.

20. The computer-implemented method of claim 19, wherein generating the region set and the explanation comprises:
(a) generating, from the partial trajectory information for the agent, an initial-condition representation;
(b) combining the initial-condition representation with the set of behavior rules to form a logic program;
(c) for each of a plurality of candidate future region assignments, performing a rule-based inference using the logic program to obtain a confidence measure for a normalcy predicate for the agent at the future time and computing a parsimony score from the confidence measure;
(d) selecting the region set based on the parsimony scores; and
(e) generating the explanation by identifying at least one behavior rule that supports at least one selected candidate future region assignment.
